(19) United States
(12) Patent Application Publication
(10) Pub. No.: US 2015/0205572 A1
(43) Pub. Date: Jul. 23, 2015

(54) DETERMINATION AND APPLICATION OF AUDIO PROCESSING PRESETS IN HANDHELD DEVICES

(71) Applicant: NVIDIA CORPORATION, Santa Clara, CA (US)

(72) Inventor: Stephen Gerald HOLMES, Fort Collins, CO (US)

(73) Assignee: NVIDIA CORPORATION, Santa Clara, CA (US)

(21) Appl. No.: 14/159,372

(22) Filed: Jan. 20, 2014

(51) Int. Cl. G06F 3/16; G06F 3/0488; G06F 3/0484; G06F 3/01

(52) U.S. Cl. CPC G06F 3/165; G06F 3/017; G06F 3/0488; G06F 3/167; G06F 3/04842

(57) ABSTRACT

One embodiment of the present invention sets forth techniques for selecting an audio environment for a handheld device. A widget detects a first input via a specially designated input mechanism. The widget enters an audio processing environment select mode based on the first input. The widget detects a second input via either the specially designated input mechanism or a second input mechanism. The widget changes an audio processing environment from a first setting to a second setting based on the second input. One advantage of the disclosed techniques is that users may change audio processing environments quickly and intuitively using existing input mechanisms such as a mute button, volume rocker control, and touch screen interface on a handheld device.

### BACKGROUND OF THE INVENTION

1. Field of the Invention

The present invention generally relates to handheld devices and, more particularly, to the determination and application of audio processing presets in handheld devices.

2. Description of the Related Art

Handheld devices, such as smartphones, pad computers, game controllers, and other mobile devices, are often used to play and record audio for a variety of applications and environments. For example, a handheld device could play back a musical track, a voice recording of a speech or discussion, audio associated with a movie, or audio associated with a computer-based game. The audio processing for each of these audio environments may be set differently in order to create an optimal listening experience. For example, when playing back a voice recording that does not include music, the audio processing may be set to emphasis audio that is detected as the human voice while suppressing non-voice audio. As a result, background audio may be suppressed, causing the spoken words spoken to be more easily understood. When playing back music, the audio processing may be set to achieve a balance between the human voice and the musical accompaniment. When playing back audio associated with a movie or a computer game, the audio processing may be set to achieve a desired balance between voice, musical background, and sound effects.

Typically, setting the audio processing for different audio environments involves traversing multiple nested menu levels. For example, a user may first need to active a “configuration” or “settings” application, select a “sounds” menu within the application, select an “environments” menu within the “sounds” menu, and then select an appropriate audio processing setup for the given environment, such as voice, music, movie, or game.

One drawback of this approach is that several levels of menus are oftentimes traversed before a user is able to select an appropriate audio processing environment for the particular media content being played. Consequently, some users may determine that the steps needed to change audio environments are too cumbersome and, therefore, may not change audio environments when switching among media content related to voice, music, movies, or games. Further, because of the difficulty in navigating to the audio processing environment menu, some users may not even be aware that audio environment control even exists. In either case, users may end up not selecting an audio processing environment that is better suited for the particular media content currently being played, which negatively impacts the overall user experience.

As the foregoing illustrates, what is needed in the art is an improved approach for selecting audio processing environments in a handheld device.

### SUMMARY OF THE INVENTION

One embodiment of the present invention sets forth a method for selecting an audio environment for a handheld device. The method includes detecting a first input via a specially designated input mechanism. The method further includes entering an audio processing environment select mode based on the first input. The method further includes detecting a second input via either the specially designated input mechanism or a second input mechanism. The method further includes changing an audio processing environment from a first setting to a second setting based on the second input.

Other embodiments include, without limitation, a computer-readable storage medium that includes instructions that enable a processing unit to implement one or more aspects of the present invention and a computing device configured to implement one or more aspects of the present invention.

One advantage of the disclosed techniques is that users may change audio processing environments quickly and intuitively using existing input mechanisms such as a mute button, volume rocker control, and touch screen interface on a handheld device. As a result, users readily select an appropriate audio processing environment based on the type of media content currently being played.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the present invention;

FIG. 2 illustrates a handheld device, according to one embodiment of the current invention;

FIG. 3 illustrates an example progression diagram of audio mode icons for indicating an audio environment for a handheld device, according to one embodiment of the present invention; and

FIG. 4 sets forth a flow diagram of method steps for selecting an audio environment for a handheld device, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details.

### System Overview

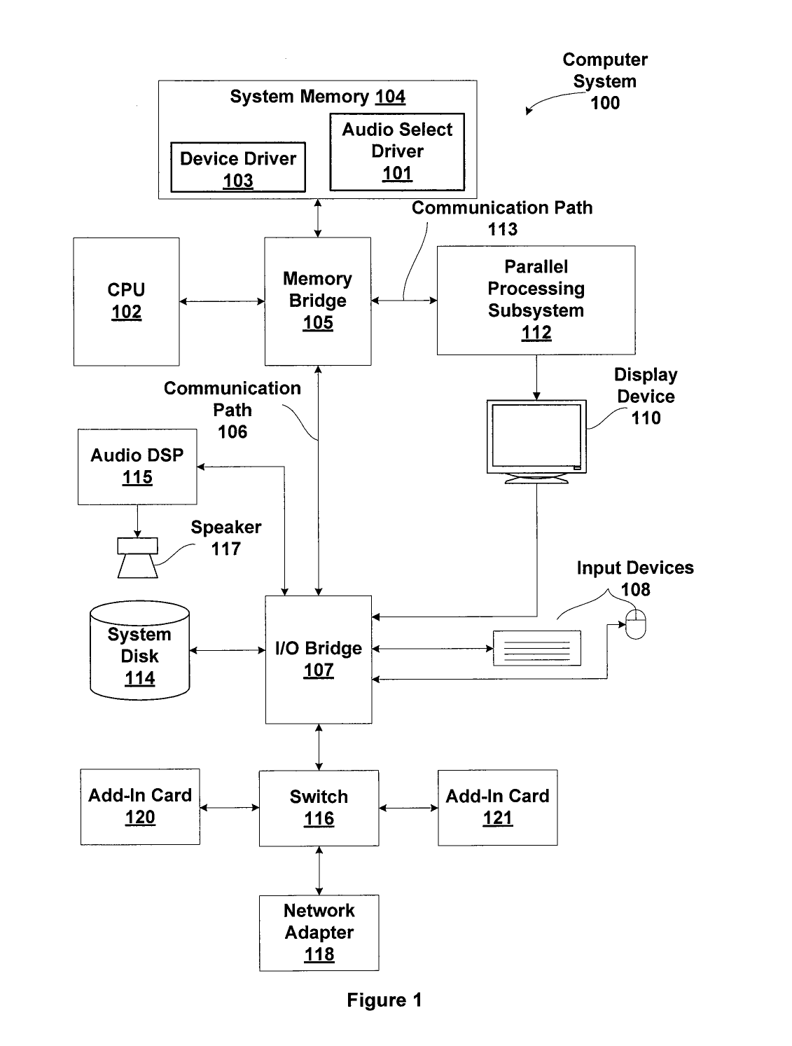

FIG. 1 is a block diagram illustrating a computer system 100 configured to implement one or more aspects of the present invention. As shown, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In operation, I/O bridge 107 is configured to receive user input information from input devices 108, such as a keyboard or a mouse, and forward the input information to CPU 102 for processing via communication path 106 and memory bridge 105. Switch 116 is configured to provide connections between I/O bridge 107 and other components of the computer system 100, such as a network adapter 118 and various add-in cards 120 and 121.

As also shown, I/O bridge 107 is coupled to a system disk 114 that may be configured to store content and applications and data for use by CPU 102 and parallel processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

An audio digital signal processor (DSP) 115 is coupled to I/O bridge 107 via a bus to receive digital audio data and control from various applications, process the digital audio data, and convert the digital audio data to an analog signal. The audio DSP 115 may include various audio functions, including, without limitation, a multiband parametric equalizer, a mixer, and an audio effects generator. The audio DSP 115 transmits the analog signal to one or more speakers such as speaker 117. In some embodiments, the audio DSP 115 transmits the digital audio data or the analog signal to a connector (not shown) configured to deliver the digital audio data or the analog signal to an external device.

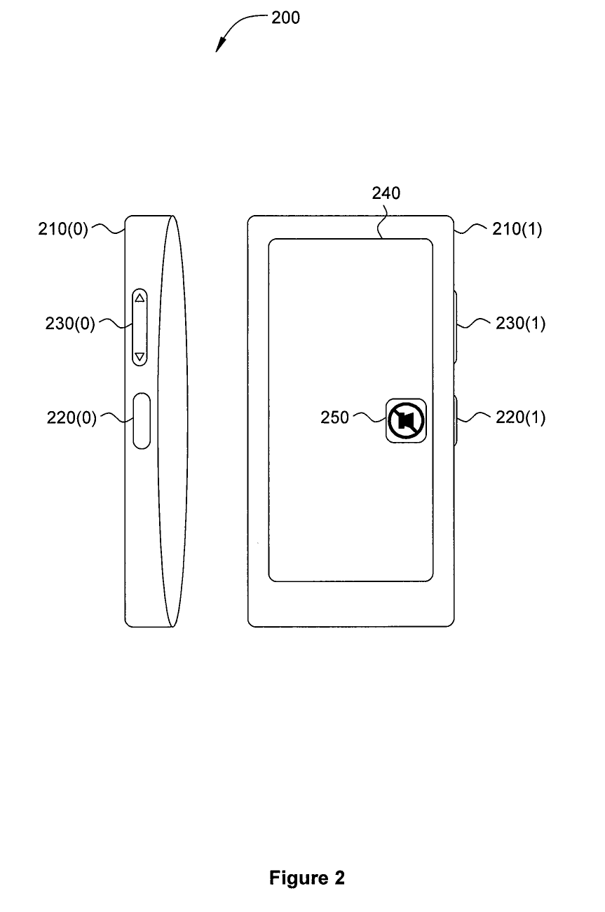

In some embodiments, parallel processing subsystem 112 is part of a graphics subsystem that delivers pixels to a display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. As described in greater detail below in FIG. 2, such circuitry may be incorporated across one or more parallel processing units (PPUs) included within parallel processing subsystem 112. In other embodiments, the parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes at least one device driver 103 configured to manage the processing operations of the one or more PPUs within parallel processing subsystem 112.

In various embodiments, parallel processing subsystem 112 may be integrated with one or more other the other elements of FIG. 1 to form a single system. For example, parallel processing subsystem 112 may be integrated with CPU 102 and other connection circuitry on a single chip to form a system on chip (SoC).

In some embodiments, a touch screen (not explicitly shown) may be integrated with the display device 110. In these embodiments, the touch screen in the display device 110 may be communicatively coupled to the I/O bridge 107. The I/O bridge 107 may be configured to receive user input information from the touch screen in the display device 110, and forward the input information to CPU 102 for processing via communication path 106 and memory bridge 105.

In some embodiments, the system memory 104 includes an audio select driver 101 configured to receive a user input and, in response to receiving a user input, cause the audio DSP 115 to change one or more parameters, as further described herein. For example, the audio select driver 101 could cause the audio DSP 115 to select a preset set of parameter values corresponding to an audio environment selection, such as voice, music, movie, or game. Alternatively, the audio select driver 101 could cause the audio DSP 115 to change the value of a parameter from a current value to a new value.

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other alternative topologies, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

### Selecting an Audio Environment for a Handheld Device

FIG. 2 illustrates a handheld device 200, according to one embodiment of the current invention. In one embodiment, the handheld device 200 may implement the computer system 100 of FIG. 1. As shown, the handheld device 200 is illustrated in a side view and in a front view. The handheld device 200 includes an enclosure 210, an audio environment select button 220, a rocker mechanism 230, a touch screen 240, and a current mode icon 250.

The enclosure 210 houses the various components of the handheld device 200, including, without limitation, the audio environment select button 220, the rocker mechanism 230, the touch screen 240, and the various components of the computer system 100 of FIG. 1.

The audio environment select button 220 is a specially designated input device that acts as a mute button for the handheld device 200 as well as a mechanism to cause the handheld device 200 to enter an audio environment select mode. When the handheld device 200 is in the audio environment select mode, the audio environment select button 220 may be used to select a particular audio processing environment, as further described herein. Pressing and releasing the audio environment select button 220 toggles the mute mode between enabling and disabling the mute function. If the audio is currently not muted, then pressing and releasing the audio environment select button 220 enables the mute function. When the mute function is enabled, no audio is transmitted to the speaker 117. If the audio is currently muted, then pressing and releasing the audio environment select button 220 disables the mute function. When the mute function is disabled, audio is transmitted to the speaker 117 according to the currently selected audio processing environment.

Pressing and holding the audio environment select button 220 causes the handheld device 200 to enter an audio environment select mode. After the handheld device 200 enters the audio environment select mode, each subsequent press of the audio environment select button 220 within a threshold amount of time since the previous press causes a different audio processing environment to be selected, according to a pre-defined sequence. For example, at power on, the handheld device 200 could select a default audio processing environment, such as a music environment. Pressing and holding the audio environment select button 220 would cause the handheld device 200 to enter an audio environment select mode with the music environment selected. Subsequent presses of the audio environment select button 220, within a threshold amount of time, would cause the handheld device 200 to enter, in turn, a voice mode, a music mode, and a game mode. If the audio environment select button 220 is not pressed within a threshold amount of time since the previous press, then the handheld device 200 would exit the audio environment select mode with the then current audio processing environment selected. This threshold amount of time before the handheld device 200 exists the audio environment select mode could be set to an initial default value. The threshold amount of time could then be changed by a user via, for example, a configuration setting.

In various embodiments, other mechanisms may be configured to detect an input that causes the handheld device 200 to enter an audio environment select mode or that causes a particular audio processing environment to be selected. Other such mechanisms may include a region of the touch screen 240 configured to sense pressure from a finger or stylus, a microphone configured to receive audio signals such as voice commands, a proximity detector configured to sense when the handheld device 200 is in contact or in close proximity to another object, and a camera configured to receive visual commands in the form of gestures. Another mechanism that may be configured to detect an input that causes the handheld device 200 to enter an audio environment select mode includes detecting multiple presses of the xx button in relatively rapid succession within a specified time interval. For example, the mechanism could detect two presses of the audio environment select button 220 in rapid succession. Alternatively, the mechanism could detect any technically feasible number of presses within the specified time interval. The number of presses and the time interval could be set to an initial default value. The number of presses and the time interval could then be changed by a user via, for example, a configuration setting.

The rocker mechanism 230 provides an input mechanism to increase or decrease a parameter. For example, if the handheld device 200 is not muted, then pressing the top portion of the rocker mechanism 230 would cause the volume of the audio produced by the speaker 117 to increase. Pressing the bottom portion of the rocker mechanism 230 would cause the volume of the audio produced by the speaker 117 to decrease.

In some embodiments, the rocker mechanism 230 may be used in conjunction with the audio environment select button 220 to provide quick access to menus that directly affect one or more parameters associated with the selected audio environment. In these embodiments, a succession of presses of the audio environment select button 220 may be used to select a particular parameter from a list of displayed parameters. The rocker mechanism 230 may be used to increase or decrease the value of a parameter. Pressing the top portion of the rocker mechanism 230 may cause the value of the selected parameter to increase. Pressing the bottom portion of the rocker mechanism 230 may cause the value of the selected parameter to decrease. A subsequent press of the audio environment select button 220 may cause the list of parameters to be displayed again, allowing the user to select a different parameter to increase or decrease.

Alternatively, the rocker mechanism 230 may be used in conjunction with the audio environment select button 220 to provide quick access to menus that directly affect one or more modes associated with the selected audio environment. A succession of presses of the audio environment select button 220 may be used to select a particular mode from a list of displayed modes. The rocker mechanism 230 may be used to enable or disable the mode. Pressing the top portion of the rocker mechanism 230 may cause the selected mode to be enabled. Pressing the bottom portion of the rocker mechanism 230 may cause the selected mode to be disabled. A subsequent press of the audio environment select button 220 may cause the list of modes to be displayed again, allowing the user to select a different mode to enable or disable.

Alternatively, the rocker mechanism 230 may be used in conjunction with the audio environment select button 220 to provide quick access to menus that directly affect both parameters and modes associated with the selected audio environment, using a combination of the parameter increase/decrease and the mode enable/disable mechanisms described above.

The touch screen 240 includes a display where a current audio processing mode may be displayed, as further described herein. As shown, the touch screen 240 includes a region where a current mode icon 250 is displayed. The current mode icon 250 illustrates a speaker symbol covered by a prohibition sign, indicating that the handheld device has been placed into mute mode. The current mode icon 250 may remain on the display associated with the touch screen 240 for an indeterminate period. Alternatively, the current mode icon 250 may be displayed on the display associated with the touch screen 240 in response to a change in the audio processing environment. The current mode icon 250 may subsequently disappear from the display associated with the touch screen 240 if the audio processing environment does not change for a threshold amount of time. For example, the current mode icon 250 could be displayed when the handheld device enters the audio environment select mode. The current mode icon 250 could be removed from the display when the handheld device subsequently exits the audio environment select mode.

In some embodiments, the touch screen 240 may be used as input device to enable a user to select an audio processing environment by pressing a specific region on the touch screen 240. The touch screen 240 may also be used as input device as input device to enable a user to increase or decrease the value of a selected parameter or to enable or disable a selected mode.

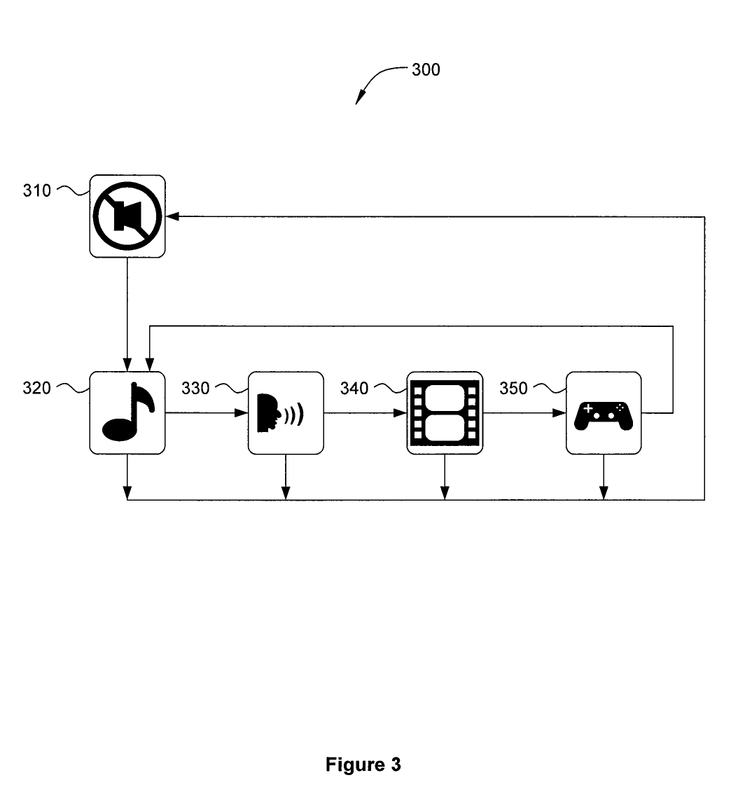

FIG. 3 illustrates an example progression diagram 300 of audio mode icons for indicating an audio environment for a handheld device, according to one embodiment of the present invention. As shown, the progression diagram 300 includes a mute icon 310, a music mode icon 320, a voice mode icon 330, a movie mode icon 340, and a game mode icon 350.

In operation, a handheld device 200 may be configured to select a default audio environment that sets initial audio playback parameters when the handheld device 200 is powered on. The default audio environment may be established at the time of manufacture or initialization of the handheld device 200. In some embodiments, a user may select or change the default audio environment. This default operation may be selected based on a typical usage of the handheld device 200. For example, a smartphone could have a voice mode as the default audio environment, a music player device could have a music mode as the default audio environment, and a gaming console could have a game mode as the default audio environment.

If the handheld device is used to play back particular media content that includes audio for a different usage, a user may change the audio environment of the handheld device 200 from the default audio environment to a different audio environment more appropriate for the particular media content. For example, if a smartphone is used to play back a musical track, then a user could change the audio environment of the smart phone from a voice mode to a music mode. If the smartphone is subsequently used to play back a movie, then the user could change the audio environment of the smart phone from the music mode to a movie mode. A typical progression of audio environments is described in further detail below.

If the handheld device 200 is in a music environment mode, and a user presses and releases the audio environment select button 220, then the handheld device 200 enters a mute mode. The mute icon 310 is then displayed on the display associated with the touch screen 240. If the user subsequently presses and holds the audio environment select button 220, then the handheld device 200 enters an audio environment select mode with the music mode selected, causing the music icon 320 to be displayed on the display associated with the touch screen 240. After the handheld device 200 enters the audio environment select mode, each subsequent press of the audio environment select button 220 within a threshold amount of time since the previous press causes a different audio processing environment to be selected. If the user presses the audio environment select button 220 a first time, then the handheld device 200 enters the voice mode, causing the voice icon 330 to be displayed on the display associated with the touch screen 240. If the user presses the audio environment select button 220 a second time, then the handheld device 200 enters the movie mode, causing the movie icon 340 to be displayed on the display associated with the touch screen 240. If the user presses the audio environment select button 220 a third time, then the handheld device 200 enters the game mode, causing the game icon 350 to be displayed on the display associated with the touch screen 240. If the user presses the audio environment select button 220 a fourth time, then the handheld device 200 enters the music mode again, causing the music icon 320 to be displayed on the display associated with the touch screen 240. If the user does not press the audio environment select button 220 for a threshold amount of time, the handheld device 200 exits the audio environment select mode and remains in the last selected audio processing mode. If the user then presses the audio environment select button 220, the handheld device 200 enters the mute mode again, causing the mute icon 310 to be displayed on the display associated with the touch screen 240.

FIG. 3 illustrates a specific sequence through a set of audio processing environments. However, all other technically feasible sequences fall within the scope of this invention.

It will be appreciated that the architecture described herein is illustrative only and that variations and modifications are possible. In one example, the handheld device 200 could enter the audio environment select mode in response to a user pressing the audio environment select button 220 twice in rapid succession, rather than pressing and holding the 220. In another example, the handheld device 200 could enter the audio environment select mode in response to a user selecting a soft button by touching a region of the touch screen 240.

In another example, the audio processing modes could be controlled via gestures made by a user, captured via a front-facing camera in the handheld device 200, and processed via various image processing approaches. If a user touches a finger to an ear, the handheld device 200 could enter the audio environment select mode. Subsequent touches to the ear could sequence through the series of audio processing environments. If the user does not touch the ear again within a threshold amount of time, the handheld device 200 would exit the audio environment select mode.

In yet another example, the handheld device 200, using a front-facing camera and image processing, could recognize various gestures to select various audio processing environments. The user could make a first with a single, index finger extended vertically over the lips to cause the handheld device to enter a mute mode. The user could extend a left hand horizontally, moving the hand up and down while the right hand waves back and forth, as if conducting an orchestra, to cause the handheld device to enter a music mode. The user could silently mouth a few words to cause the handheld device to enter a voice mode. The user could rotate a clenched hand as if operating an old hand crank movie camera to cause the handheld device to enter a movie mode. Finally, the user could hold one or both hands and move the thumbs as if controlling a computer game to cause the handheld device to enter a game mode.

In yet another example, a proximity detector associated with the handheld device 200 could detect when the user touches or taps an area on the handheld device 200. A specific series of touches or taps could cause the handheld device 200 to enter the audio environment select mode, sequence through a series of audio processing environments to select a desired environment, and then exit the audio environment select mode.

In yet another example, the audio processing environment could be selected via voice command. The handheld device 200 could be tuned to recognize the voice of particular users and identify spoken commands or fixed word sequences. For an English speaker, the commands to change the audio processing environment could include commands such as “audio mode” or “playback mode” to enter an audio environment select mode. The user could then issue additional spoken commands, such as, “music,” “movie,” “game,” “voice,” “mute,” “volume up,” or “volume down.” The handheld device 200 could also recognize natural language phrases such as “set the playback mode to music” to change the audio processing environments.

In an alternative embodiment, placing a mobile device in record mode, such as by pressing a physical button or a soft button via the touch screen 240, may cause a control panel to be displayed on the display of the handheld device 200. The user could then select from among various audio processing environments associated with recording, including, without limitation, recording in a quiet room, in a café, or on a busy street. For example, audio processing environments associated with recording could be selected. A sensor near or within the microphone could detect a user touch or tap could to enter an audio environment select mode for recording.

Additional touches, taps, gestures, or voice commands could cycle through the different recording modes for mute, voice, music, or movie. The record modes for voice mode would retune the equalizer to settings to bring out voice, change record sample rates to lower frequencies for power savings, and turn-on noise suppression, beam-forming, and acoustic echo cancellation for voice enhancements. The record modes for music mode would calibrate equalizer settings and recording sample rates to enhance the audio quality of the music being recorded. The record modes for movie mode would be similar to music with higher sampling frequencies, but with different equalizer settings. Mute mode would silence the data coming into the microphone.

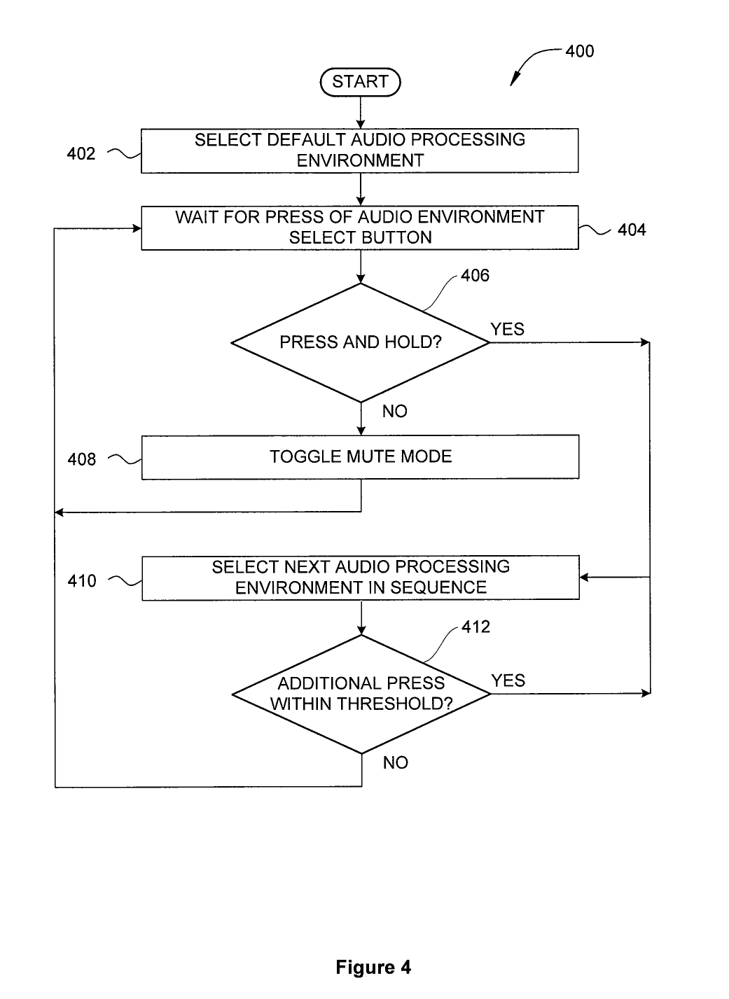

FIG. 4 sets forth a flow diagram of method steps for selecting an audio environment for a handheld device, according to one embodiment of the present invention. Although the method steps are described in conjunction with the systems of FIGS. 1-3, persons of ordinary skill in the art will understand that any system configured to perform the method steps, in any order, is within the scope of the inventions.

As shown, a method 400 begins at step 402, where the audio select driver 101 selects a default audio processing environment 402. At step 404, the audio select driver 101 waits for the audio environment select button 220 to be pressed. When a press of the audio environment select button 220 is detected, the method 400 proceeds to step 406, where the audio select driver 101 determines whether the user has pressed and held the audio environment select button 220. If the user has not pressed and held the audio environment select button 220, then the method proceeds to step 408. At step 408, the audio select driver 101 toggles the mute mode from off to on, or from on to off, as appropriate. The method 400 then proceeds to step 404, described above.

Returning to step 406, if the user has pressed and held the audio environment select button 220, then the method 400 proceeds to step 410. At step 410, the audio select driver 101 selects the next audio processing environment in a pre-determined sequence. At step 412, the audio select driver 101 determines whether the audio environment select button 220 has been pressed again within a threshold amount of time. If the audio environment select button 220 has been pressed within the threshold amount of time, then the method 400 proceeds to step 410, described above. If, however, the audio environment select button 220 has not been pressed within the threshold amount of time, then the method 400 proceeds to step 404, described above.

In sum, a user causes a handheld device to toggle between mute on and mute off by pressing and releasing an audio environment select button. If the user presses and holds the audio environment select button, the handheld device enters an audio environment select mode. Subsequent presses of the audio environment select button selects various preselected audio processing environments. If the audio environment select button is not pressed again for a threshold amount of time, then the handheld device exits the audio environment select mode with the current selected audio processing environment. Alternatively, the user may select various audio processing environments by a series of taps to the handheld device, by various physical gestures, or by voice commands. Audio processing environments related to recording may also be selected using similar approaches.

One advantage of the disclosed techniques is that users may change audio processing environments quickly and intuitively using a combination of the existing mute button, volume rocker control, and touch screen interface on a handheld device. As a result, users readily select an appropriate audio processing environment based on the type of media content currently being played.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as compact disc read only memory (CD-ROM) disks readable by a CD-ROM drive, flash memory, read only memory (ROM) chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons of ordinary skill in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

Therefore, the scope of embodiments of the present invention is set forth in the claims that follow.

What is claimed is:

1. A method for selecting an audio environment for a handheld device, the method comprising:
detecting a first input via a specially designated input mechanism;
entering an audio processing environment select mode based on the first input;
detecting a second input via either the specially designated input mechanism or a second input mechanism; and
changing an audio processing environment from a first setting to a second setting based on the second input.

2. The method of claim 1, wherein the specially designated input device comprises an audio environment select button included on an enclosure of the handheld device.

3. The method of claim 2, wherein the first input comprises pressing and holding the audio environment select button.

4. The method of claim 3, wherein the second input comprises releasing and pressing the audio environment select button within a threshold amount of time.

5. The method of claim 1, further comprising:
determining that a third input is not received via either the specially designated input device or the second input device within a threshold amount of time; and
in response, exiting the audio processing environment select mode.

6. The method of claim 1, wherein the first setting is a music mode, a voice mode, a movie mode, or a game mode.

7. The method of claim 6, wherein the second setting is a music mode, a voice mode, a movie mode, or a game mode.

8. The method of claim 1, wherein the second input device comprises a camera associated with the handheld device, and the second input comprises a physical gesture performed by a user and detected by the second input device.

9. The method of claim 1, wherein the second input device comprises a microphone associated with the handheld device, and the second input comprises a voice command spoken by a user and detected by the second input device.

10. The method of claim 1, wherein the second input device comprises a touch screen associated with the handheld device, and the second input comprises a touching of a region associated with the touch screen by a user and detected by the second input device.

11. A method for selecting an audio environment for a handheld device, the method comprising:
detecting a first input via a specially designated input mechanism;
entering an audio processing environment select mode based on the first input;
detecting a second input via either the specially designated input mechanism or a second input mechanism; and
changing an audio processing environment from a first setting to a second setting based on the second input;
wherein the second input device comprises a proximity detector associated with the handheld device, and the second input comprises a physical touching of the handheld device by a user and detected by the second input device.

12. A computer-readable storage medium including instructions that, when executed by a processing unit, cause the processing unit to perform an operation for selecting an audio environment for a handheld device, the operation comprising:
detecting a first input via a specially designated input mechanism;
entering an audio processing environment select mode based on the first input;
detecting a second input via either the specially designated input mechanism or a second input mechanism; and
changing an audio processing environment from a first setting to a second setting based on the second input.

13. The computer-readable storage medium of claim 12, wherein the specially designated input device comprises an audio environment select button included on an enclosure of the handheld device.

14. The computer-readable storage medium of claim 13, wherein the first input comprises pressing and holding the audio environment select button.

15. The computer-readable storage medium of claim 14, wherein the second input comprises releasing and pressing the audio environment select button within a threshold amount of time.

16. The computer-readable storage medium of claim 12, wherein the operation further comprises:
determining that a third input is not received via either the specially designated input device or the second input device within a threshold amount of time; and
in response, exiting the audio processing environment select mode.

17. The computer-readable storage medium of claim 12, wherein the first setting is a music mode, a voice mode, a movie mode, or a game mode.

18. The computer-readable storage medium of claim 17, wherein the second setting is a music mode, a voice mode, a movie mode, or a game mode.

19. The computer-readable storage medium of claim 12, wherein the second input device comprises a camera associated with the handheld device, and the second input comprises a physical gesture performed by a user and detected by the second input device.

20. A computing device for selecting an audio environment for a handheld device, comprising:
a processing unit; and
a memory containing instructions, that, when executed by the processing unit, cause the processing to:
detect a first input via a specially designated input mechanism;
enter an audio processing environment select mode based on the first input;
detect a second input via either the specially designated input mechanism or a second input mechanism; and
change an audio processing environment from a first setting to a second setting based on the second input.
